(19) United States
(12) Patent Application Publication
(10) Pub. No.: US 2019/0339192 A1
(43) Pub. Date: Nov. 7, 2019

(54) AGING APPARATUS

(71) Applicant: Sharp Kabushiki Kaisha, Sakai City, Osaka (JP)

(72) Inventor: Kenji OHNUMA, Sakai City (JP)

(73) Assignee: Sharp Kabushiki Kaisha, Sakai City, Osaka (JP)

(21) Appl. No.: 16/464,719

(22) PCT Filed: Jun. 7, 2017
(86) PCT No.: PCT/JP2017/021130

§ 371 Date: May 29, 2019

(51) Int. Cl. G01N 17/00

(52) U.S. Cl. CPC G01N 17/004; G01N 2203/022; G01N 17/002

(57) ABSTRACT

An aging apparatus wherein a chamber has a cylindrical shape, a chamber shelf is rotatably disposed in an interior of the chamber, and the chamber shelf enables a plurality of aging target objects to be installed in the direction of a rotating shaft.

### TECHNICAL FIELD

The disclosure relates to an aging apparatus.

### BACKGROUND ART

Aging is performed at various stages and on various aging target objects from time to time in production of products. In addition, even after products are completed, aging is performed on the products.

In aging, temperature accuracy within a chamber of an aging apparatus, uniform temperature distribution within the chamber, and the like are required. In storing a plurality of aging target objects within the chamber, in particular, a uniform temperature distribution within the chamber becomes important.

### CITATION LIST

### Patent Literature

PTL 1: JP 2015-138756 A (published on Jul. 30, 2015).

PTL 2: JP 9-205043 A (published on Aug. 5, 1997).

### SUMMARY

### Technical Problem

A problem of the disclosure is to solve is how to provide an aging apparatus with enhanced uniformity of temperature distribution within a chamber.

### Solution to Problem

According to an aspect of the disclosure, there is provided an aging apparatus for aging a plurality of aging target objects by installing the plurality of aging target objects within a chamber, wherein the chamber has a cylindrical shape, a chamber shelf is rotatably disposed in an interior of the chamber, and the chamber shelf enables the plurality of aging target objects to be installed in a direction of a rotational shaft.

### Advantageous Effects of Disclosure

According to an aspect of the disclosure, it is possible to provide an aging apparatus with enhanced uniformity of temperature distribution within the chamber.

### BRIEF DESCRIPTION OF DRAWINGS

FIG. 1 is a drawing schematically illustrating an aging apparatus.

FIG. 2 is a drawing schematically illustrating an aging apparatus of another aspect.

FIG. 3 is a drawing schematically illustrating a chamber shelf of another aspect.

FIG. 4 is a flow chart illustrating an example of a manufacturing method of an Electro Luminescent (EL) display panel.

FIG. 5A is a cross-sectional view illustrating a configuration example of an EL display device of the present embodiment under formation, and FIG. 5B is a cross-sectional view illustrating a configuration example of the EL display device of the present embodiment.

### DESCRIPTION OF EMBODIMENTS

### First Embodiment

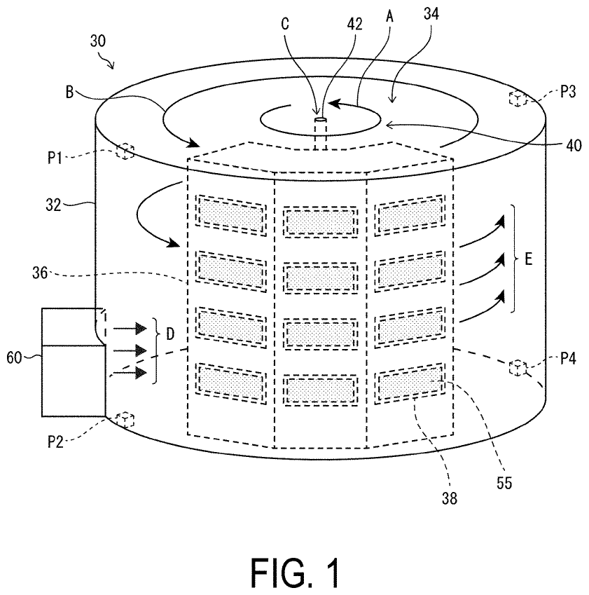

FIG. 1 is a drawing schematically illustrating an aging apparatus 30 of the present embodiment.

As illustrated in FIG. 1, the aging apparatus 30 of the present embodiment includes a housing 32, a chamber 34, a chamber shelf 36, a rotating portion 40, and a hot air blower device 60.

The housing 32 has a cylindrical shape, and the chamber 34 is disposed in an interior of the housing 32. The chamber shelf 36 is provided in the chamber 34. Then, the chamber shelf 36 is coupled to the rotating portion 40 provided in the chamber 34, whereby the chamber shelf 36 can rotate in the interior of the chamber 34.

In the example illustrated in FIG. 1, the rotating portion 40 can rotate about a rotating shaft 42 positioned substantially in a central position of the cylindrical housing 32 as a rotating axis. Then, the chamber shelf 36 coupled to the rotating portion 40 rotates along an inner wall of the housing 32 about the rotating shaft 42 as a center of rotation thereof.

Hereinafter, the constituent members will be described sequentially.

Chamber Shelf

The chamber shelf 36 has substantially an arc shape in a plan view from above. That is, the chamber shelf 36 is not provided in a total circular shape corresponding to a total circumference of a cylindrical shape defined along an inner wall of the cylindrical housing 32 but is provided in the arc shape in a position along the circumference of the inner wall of the cylindrical housing 32.

The chamber shelf 36 includes an installing portion 38 for installing of the aging target object 55. The shape of the installing portion 38 is not limited to any particular shape and is designed as required, for example, in such a manner as to match the shape of the aging target object 55 or the like. In the example illustrated in FIG. 1, the aging target object 55 has a flat plate shape, and hence, the installing portion 38 is provided so that the aging target object 55 can be disposed on an outer wall (an outer circumferential surface) of the chamber shelf 36.

Another installing portion 38 is raised as an example of the installing portion 38, and this installing portion 38 is given a hole shape or a shelf shape by depressing the outer wall of the chamber shelf 36 to deal with a case where the aging target object 55 is given a three-dimensional shape.

A plurality of such installing portions 38 are provided on the chamber shelf 36 in such a manner as to be aligned in not only a vertical direction (an up-and-down direction, an extending direction of the rotating shaft) but also in a horizontal direction (a left-and-right direction) that is a direction intersecting the vertical direction at a right angle. In the example illustrated in FIG. 1, a total of 12 installing portions 38 are provided on the outer wall of the chamber shelf 36 in four rows and three columns.

This enables a plurality of such aging target objects 55 to be installed on the chamber shelf 36. In the example illustrated in FIG. 1, one chamber shelf 36 includes 12 aging target objects 55 that are installed thereon.

Rotating Portion

The rotating portion 40 includes a control unit (not illustrated) configured to control the rotation of the rotating portion 40, the rotating shaft 42, a coupling portion (not illustrated) configured to couple the rotating shaft 42 and the chamber shelf 36 together, and the like.

In the present embodiment, the casing 32 has the cylindrical shape, and the rotating shaft 42 is disposed substantially in the central position C of the cylindrical shape.

The arc-shaped chamber shelf 36 is positioned on a circumference centered at the rotating shaft 42 and extends along an inner wall of the housing 32. Then, the chamber shelf 36 and the rotating shaft 42 are coupled together via the coupling portion. Due to this, the chamber shelf 36 rotates (as indicated by an arrow B in FIG. 1) along the inner wall of the casing 36 as a result of the rotating portion 40 rotating (as indicated by an arrow A in FIG. 1).

Air in an interior of the chamber 34 moves as the chamber shelf 36 rotates, whereby an air flow is generated in the chamber 34. In the present embodiment, the chamber shelf 36 does not have the circular shape but has the arc shape in the plan view from above. This makes it easier for air to move when the chamber shelf 36 rotates than when a circular chamber shelf 36 rotates. Further, in a case where the chamber shelf has a cylindrical shape (circular in a plan view), it is difficult for air between an interior and an exterior of a cylinder to be separated. Thus, in the case where the chamber shelf 36 has the arc shape in the plan view, the accuracy (uniformity) of a temperature distribution in an interior of the chamber 34 tends to be improved easily.

Rotation Speed

Although the rotation speed of the rotating portion 40 is not limited to any particular rotation speed, the rotation speed of the rotating portion 40 is preferably a rotation speed generating an air flow. This is because air moving in the interior of the chamber 34 facilitates producing a uniform temperature distribution in the interior of the chamber 34. Note that the rotating portion 40 rotates at a low rotation speed of 10 or less revolutions per minute and that the rotation speed can be set within a range of 1 km/h to 10 km/h in 1 km/h increments.

Hot Air Blower Device

Hot air is supplied into the chamber 34 from the hot air blower device 60 provided in the exterior of the casing 32. Air in the interior of the chamber 34 is heated as a result of hot air being supplied into the interior of the chamber 34, and additionally, an air flow is generated in the interior of the chamber 34.

The hot air blower device 60 controls the temperature, flow velocity, flow rate, direction and the like of hot air as required according to the aging temperature, the temperature and temperature distribution in the interior of the chamber 34, the flow velocity, flow rate or direction of an air flow, the temperature of an aging target object, and the like.

Additionally, measuring devices or the like that can measure a temperature and temperature distribution in the interior of the chamber 34, a flow velocity, flow rate or direction of an air flow, a temperature of an aging target object 55 and the like are provided as required in the chamber 34. FIG. 1 illustrates a configuration example in which four temperature sensors 4 configured to measure a temperature are provided.

In the present embodiment, the hot air blower device 60 is described as being provided in the exterior of the housing 32. However, the position of the hot air blower device 60 is not limited to this configuration, and hence, the hot air blower device 60 may be disposed in the interior of the housing 32.

Flow of Hot Air, Air Flow, Temperature Distribution

In the present embodiment, hot air is supplied from the hot air blower device 60 into the interior of the chamber 34 as indicated by arrows D. Then, as a result of the chamber shelf 36 rotating as indicated by the arrow B, an air flow flowing in the same direction as a rotating direction of the chamber shelf 36 is generated in the interior of the chamber 34 (as indicated by arrows E). This produces a uniform temperature distribution in the interior of the chamber 34, improving the accuracy of the temperature distribution.

In the present embodiment, the chamber 34 has a cylindrical shape. Due to this, compared with a case where the chamber has, for example, a rectangular parallelepiped shape, the aging apparatus 30 can easily be reduced in size, whereby the space where the aging apparatus 30 is set can be conserved, and in addition to this, the temperature distribution in the interior of the chamber 34 can be made uniform easily.

In the present embodiment, the chamber shelf 36 is not fixed but can move (rotate). Due to this, the chamber shelf 36 rotates to thereby generate an air flow easily in the interior of the chamber 34, and the air flow generated is stabilized easily. Thus, the temperature distribution in the interior of the chamber 34 can be made uniform easily.

In addition, as a result of the chamber shelf 36 rotating, aging target objects 55 installed on the chamber shelf 36 do not stay in a constant position but are caused to move sequentially to different locations in the interior of the chamber 34. This facilitates the uniformity in temperature of the aging target objects 55 installed on the chamber shelf 36.

In the present embodiment, the chamber shelf 36 has an arc shape. Due to this, compared with a case where the chamber shelf 36 has a cylindrical shape, an air flow is generated more easily in the interior of the chamber 34 as a result of rotation of the chamber shelf 36. Additionally, as compared with the case where the chamber shelf 36 has a cylindrical shape, the temperature distribution in the interior of the chamber 34 tends to be uniform more easily. This is because air is not separated between an inside and an outside of the cylindrical shape. Further, compared with a case where the chamber shelf has a rectangular parallelepiped shape, a space required for rotation of the chamber shelf can be reduced.

Sensors

In the present embodiment, as an example of the measuring devices described before, temperature sensors P1 to P4 are provided in the interior of the chamber 34. As illustrated in FIG. 1, the temperature sensors P1 to P4 are provided in a high position (P1 and P3) and a low position (P2 and P4) in the chamber 34. The temperature sensors P1 and P2 and the temperature sensors P3 and P4 are provided substantially in opposite positions in the interior of the chamber 34.

The temperature distribution in the whole of the interior of the chamber 34 can be grasped easily by providing the temperature sensors P1 to P4 as described above.

Here, the accuracy of the temperature distribution in the interior of the chamber 34 is referred to as a difference between a set temperature of aging and a temperature measured by the temperature sensors P1 to P4. In the aging apparatus 30 of the present embodiment, the accuracy of the temperature distribution is +/−2° C. and can preferably be +/−1° C.

In contrast to this, a known aging apparatus has an accuracy of temperature distribution of +/−3° C. When referred to herein, the known aging apparatus denotes an aging apparatus having a rectangular parallelepiped chamber and a fixed chamber shelf.

In the case with the chamber shelf 36 of the present embodiment where the plurality of aging target objects 55 are disposed in the vertical direction, in particular, a temperature difference between an upper portion and a lower portion in the interior of the chamber 34 poses a problem. Additionally, a temperature difference tends to be generated easily between the upper portion and the lower portion in the interior of the chamber 34. With regard to this problem, in the aging apparatus 30 of the present embodiment, good accuracy of temperature distribution is realized by the sensors P1 and P3 provided in the high position, and by the sensors P2 and P4 provided in the low position, as well.

### Second Embodiment

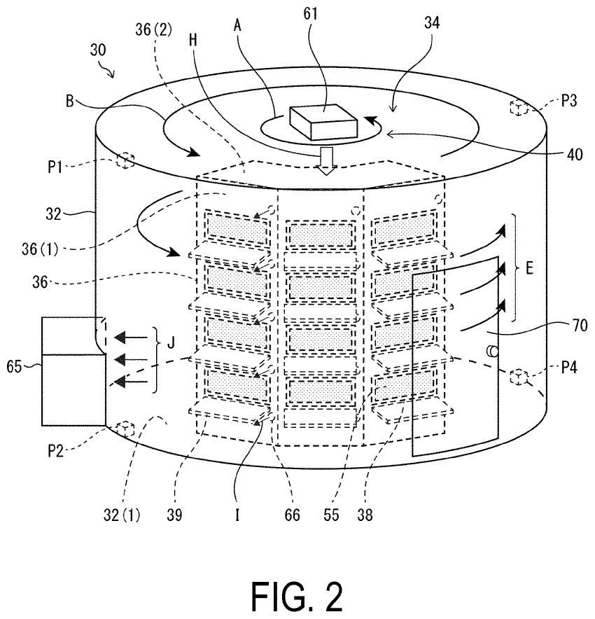

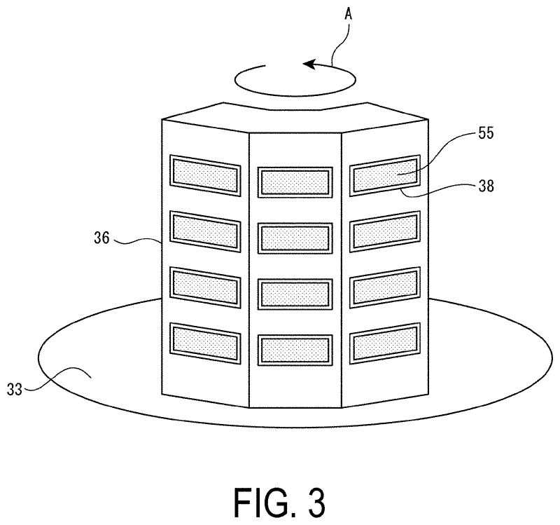

A second embodiment of the disclosure will be described as below based on FIGS. 2 and 3. Note that members having the same function as the members stated in the embodiment above are appended with the same reference signs for the sake of description, and the description thereof is omitted.

An aging apparatus 30 of the present embodiment differs from the aging apparatus 30 of the first embodiment in the way in which hot air flows. That is, in the first embodiment, hot air is supplied from the hot air blower device 60 provided on a side surface of a lower portion of the housing 32 towards the interior of the chamber 34 (as indicated by the arrows D). In contrast to this, in the present embodiment, hot air is supplied from a top to a bottom of the chamber 34 as illustrated in FIG. 2. Then, hot air is exhausted from a lower portion of a housing 32 towards an exterior of the chamber 34. Hereinafter, a more specific description will be made as follows.

In the aging apparatus 30 of the present embodiment, as illustrated in FIG. 2, a hot air blower device 61 is provided in a central position of an upper portion of the housing 32. An exhaust mechanism 65, configured to exhaust air in an interior of the chamber 34 to the exterior of the chamber 34, is provided on a side surface of a lower portion of the housing 32.

Further, ventilation ports 66 constituting ventilation holes are provided on a chamber shelf outer surface 36(1) of a chamber shelf 36. These ventilation ports 66 are provided individually for installing portions 38. In the present embodiment, the ventilation port 66 is provided at a side of the installing portion 38, the side constituting a rotating direction side (a distal end direction side of an arrow A) when the chamber shelf 36 rotates.

Hot air blown out of the hot air blower device 61 enters an interior of the chamber shelf 36 from a chamber shelf upper portion 36(2) constituting an upper portion of the chamber shelf 36 (as indicated by an arrow H in FIG. 2). The hot air entering the interior of the chamber shelf 36 exits from the ventilation ports 66 to an outside of the chamber shelf 36 (as indicated by an arrow I in FIG. 2). As this occurs, since the ventilation ports 66 are provided at the chamber shelf rotating direction side of the corresponding installing portions 38, the hot air that exits from the ventilation ports 66 is likely to strike against the aging target objects 55 (as indicated by the arrow I in FIG. 2). Thus, aging is executed effectively.

The hot air blown out of the ventilation ports 66 is exhausted from the exhaust mechanism 65 to the exterior of the chamber 34. In the present embodiment, the hot air blower device 61 configured to blow out hot air is provided at the upper portion of the chamber 34, and the exhaust mechanism 65 configured to exhaust hot air is provided at the lower portion of the chamber 34. This generates a flow of hot air flowing downward from the top of the interior of the chamber 34 to thereby expel air of a relatively low temperature staying at the bottom of the chamber to the exterior of the chamber 34 effectively.

Additionally, the hot air blower device 61 is provided near the upper portion (the chamber shelf upper portion 36(2)) of the chamber shelf 36, whereby hot air supplied from the hot air blower device 61 is introduced into the chamber shelf 36. Then, the hot air introduced is jetted individually to the aging target objects 55 by way of the ventilation ports 66 provided individually for the installing portions 38. This facilitates uniform aging of the individual aging target objects 55.

Door

In the present embodiment, a door 70 is provided in the housing 32 to gain access to the chamber 34.

Opening and closing of the door 70 can be interlocked with rotation of the chamber shelf 36. Although details of a rotating portion 40 such as a rotating shaft and the like are omitted from illustration in FIG. 2, as in the case with the aging apparatus 30 of the first embodiment, a rotating mechanism (the rotating portion 40) is also provided in the aging apparatus 30 of the present embodiment.

As a way of interlocking the door 70 with the chamber shelf 36 as described above, for example, stopping rotation of the chamber shelf 36 when the door 70 is opened can be considered. Adopting this configuration obviates the necessity of an operation to stop the rotation of the chamber shelf 36, thereby making it possible to simplify the working procedure.

In addition, since opening the door 70 stops the rotation of the chamber shelf 36 (causes the chamber shelf 36 to start stopping), compared with a case where a separate operation is performed to stop the rotation of the chamber shelf 36, a waiting time until requested work is started (until the rotation of the chamber shelf 6 stops) can be reduced.

To start the rotation of the chamber shelf 36, for example, the door 70 is closed, and then, a switch provided outside the housing 32 is operated to start the rotation of the chamber shelf 36. Alternatively, the chamber shelf 36 can also be made to start rotating in association with closure of the door 70.

Working Shelf

Various specific configurations of the chamber shelf 36 including configurations of the installing portion 38 can be considered based on, for example, types and sizes of the aging target object 55. FIG. 2 illustrates a configuration example where a working shelf 39 is provided below each installing portion 38. Providing the working shelf 39 at each installing portion 38 can improve the working efficiency.

Interior of Chamber

In the interior of the chamber 34, only the chamber shelf 36 can be made to rotate with a floor 32(1) (refer to FIG. 2) of the housing 32 kept from rotating. Alternatively, as illustrated in FIG. 3, a chamber shelf table 33 configured to rotate together with the chamber shelf 36 may be provided at a portion underneath the chamber shelf 36.

When the chamber shelf table 33 is provided, since a working person can work while standing on the chamber shelf table 33, the rotation of the chamber shelf 36 does not have to be stopped during the work. As a result, the working efficiency can be improved.

In addition, when the chamber shelf 36 rotates together with the chamber shelf table 33, the interlocking of the door 70 with the chamber shelf 36 is no longer needed, thereby making it possible to simplify the apparatus.

Other Configurations

Note that the configuration of the aging apparatus 30 is not limited to the configurations that have been described heretofore.

For example, although the chamber shelf 36 is described as having an arc shape extending substantially one fourth of the circumference in FIG. 1, the configuration of the chamber shelf 36 is not limited thereto. For example, the chamber shelf 36 can have a semi-circular shape extending substantially one half of the circumference. Besides having the arc shape, the chamber shelf 36 can have a cylindrical shape corresponding to a full circumference.

A member such as a projection or a blade configured to facilitate the generation or control of an air flow can also be provided on the chamber shelf 36 so as to facilitate the generation of an air flow or/and to facilitate the stabilization of the air flow when rotating.

Aging Target Object

The aging apparatus 30 of the present embodiment can age various types of aging target objects 55. For example, the aging apparatus 30 is used preferably to age flexible displays among displays. Hereinafter, an EL display panel will be described as an example of such a flexible display.

Display Panel

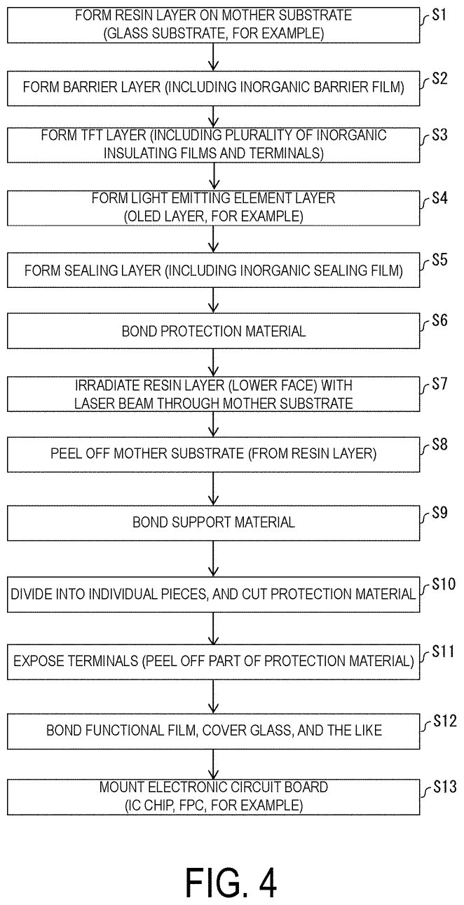

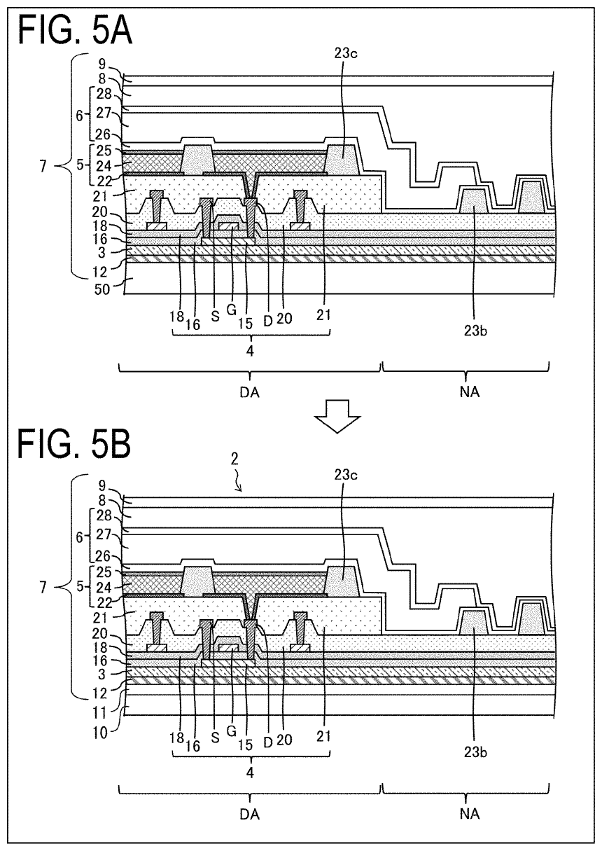

FIG. 4 is a flow chart illustrating a manufacturing method of an EL display panel 2 as an example of a flexible display panel 2. FIG. 5A is a cross-sectional view illustrating a configuration example of the EL display panel 2 of the present embodiment under formation. FIG. 5B is a cross-sectional view illustrating a configuration example of the EL display panel 2 of the present embodiment.

When a flexible EL display panel is manufactured, as illustrated in FIGS. 4 to 5B, the following steps from step S1 to step S13 will be followed.

Step S1: Form a resin layer 12 on a light transmitting mother substrate 50 such as a glass substrate.

Step S2: Form an inorganic barrier layer 3.

Step S3: Form a thin film transistor (TFT) layer including a plurality of inorganic insulating films 16, 18, 20 and a flattening film 21.

Step S4: Form a light emitting layer 5 such as an OLED element layer or the like.

Step S5: Form a sealing layer 6 including inorganic sealing films 26, 28 and an organic sealing film 27.

Step S6: Bond a protection material 9 such as a PET film or the like onto the sealing layer 6 via a bonding layer 8.

Step S7: Irradiate the resin layer 12 with a laser beam. Here, a lower surface of the resin layer 12 that constitutes an interface with the mother substrate 50 is modified by abrasion as a result of the resin layer 12 absorbing the irradiated laser beam. This forms a peel-off layer to thereby reduce a bonding force between the resin layer 12 and the mother substrate 50.

Step S8: Peel off the mother substrate 50 from the resin layer 12. This peels off a layered body 7 from the mother substrate 50. When referred to herein, the layered body 7 denotes a whole of a multi-layered body formed on the mother substrate 50, and in the example illustrated in FIG. 5A, the layered body 7 denotes layers from the resin layer 12 formed on the mother substrate 50 to the protection material 9 constituting an outermost layer.

Step S9: Bond a support material 10 such as a PET film or the like to the lower surface of the resin layer 12 via a bonding layer 11.

Step S10: Divide the mother substrate 50 and cut the protection material 9 to thereby cut out a plurality of EL display panels.

Step S11: Peel off the protection material 9 on a terminal portion of the TFT layer 4 to expose a terminal.

Step S12: Bond a functional film (not illustrated).

Step S13: Mount an electronic circuit board on the terminal portion by use of ACF or the like.

Thus, the EL display panel 2 as the example of the flexible display is formed. Note that a manufacturing apparatus executes all the steps described above.

In FIGS. 5A and 5B, reference numeral 4 denotes a TFT layer, reference numeral 15 a semiconductor film, reference numeral 16 an inorganic insulating film (a gate insulating film), reference numeral 22 an anode electrode, reference numeral 23b a bank, reference numeral 23c an isolation wall, reference numeral 24 an Electro Luminescence (EL) layer, reference numeral 25 a cathode electrode, reference numeral 26 a first inorganic sealing film (an inorganic sealing film), reference numeral 27 an organic sealing film, reference numeral 28 a second inorganic sealing film (an inorganic sealing film), reference character G a gate electrode, reference character S a source electrode, reference character D a drain electrode, reference character DA an active region, and reference character NA a non-active region.

The active DA region corresponds to a region where the light emitting layer 5 is formed (a region where the semiconductor film 15, the gate electrode G, the source electrode S and the drain electrode D are formed) and can also be referred to as a display region. On the other hand, the non-active region NA is a region other than the active region DA and a region where a terminal is formed which is used for connection with the electronic circuit board or the like.

Aging Process

In manufacturing the EL display panel, an aging process is performed after step S10 described above, and the EL display panel so aged is determined to be good or defective in a panel inspection process immediately after the aging process. Aging using the aging apparatus 30 of the present embodiment can be executed after the process in step S10.

In flexible displays, since luminance deteriorates greatly in an initial stage and varies from panel to panel in many cases, when the flexible displays are aged using the aging apparatus 30 of the present embodiment, the luminance can be promoted to a stable region.

Flexible Display

The flexible display used in the aging apparatus 30 of the present embodiment is not limited to any particular flexible display, provided that a flexible display to be used is a display panel including a bendable light emitting element. The light emitting element is a light emitting element of which the luminance and transmittance are controlled by an electric current, and examples of the electric current-controlled light emitting element include an organic Electro Luminescence (EL) display provided with an Organic Light Emitting Diode (OLED), an EL display such as an inorganic EL display provided with an inorganic light emitting diode, or a QLED display provided with a Quantum Dot Light Emitting Diode (QLED).

Supplement

An aging apparatus according to a first aspect of the disclosure is an aging apparatus for aging a plurality of aging target objects by installing the plurality of aging target objects within a chamber, wherein the chamber has a cylindrical shape, a chamber shelf is rotatably disposed in an interior of the chamber, and the chamber shelf enables the plurality of aging target objects to be installed in the direction of a rotational shaft.

In an aging apparatus according to a second aspect of the disclosure, the chamber shelf has an arc shape in a plan view from the direction of the rotating shaft.

In an aging apparatus according to a third aspect of the disclosure, the rotating shaft is positioned at a center of the chamber.

In an aging apparatus according to a fourth aspect of the disclosure, the chamber shelf rotates at a rotation speed of 10 or less revolutions per minute and from 1 km/h to 10 km/h.

In an aging apparatus according to a fifth aspect of the disclosure, a hot air blower device is provided at an upper portion of the chamber, and an exhaust mechanism is provided at a lower portion of the chamber.

In an aging apparatus according to a sixth aspect of the disclosure, the chamber shelf includes a plurality of installing portions for installing of the aging target objects, and the chamber shelf includes ventilation ports provided individually for the installing portions.

In an aging apparatus according to a seventh aspect of the disclosure, the ventilation ports are provided at the chamber shelf rotating direction side of the corresponding installing portions.

In an aging apparatus according to an eighth aspect of the disclosure, the chamber shelf includes working shelves provided individually for the installing portions.

In an aging apparatus according to a ninth aspect of the disclosure, a door is provided in a housing that covers the chamber, and opening and closing of the door is interlocked with rotation of the chamber shelf.

In an aging apparatus according to a 10th aspect of the disclosure, the rotation stops in association with opening the door.

In an aging apparatus according to an 11th aspect of the disclosure, a chamber shelf table configured to rotate together with the chamber shelf is provided at a lower portion of the chamber shelf.

Combinations

The disclosure is not limited to the embodiments that have been described above, and embodiments obtained by appropriately combining the technical approaches disclosed in the different embodiments also fall within the technical scope of the disclosure. Moreover, novel technical features may be formed by combining the technical approaches stated in each of the embodiments.

### REFERENCE SIGNS LIST

2 EL display panel (Display panel)

4 TFT layer

3 Inorganic barrier film

5 Light emitting element layer

6 Sealing layer

7 Layered Body

8, 11 Bonding layer

9 Protection material

10 Support material

12 Resin layer

15 Semiconductor film

16 Inorganic insulating film (Gate insulating film)

18, 20 Inorganic insulating film

21 Flattening film

22 Anode electrode

23B Bank

23C Isolation wall

24 EL layer

25 Cathode electrode

26 First inorganic sealing film

26 Inorganic sealing film (Second inorganic sealing film)

27 Organic sealing film

28 Inorganic sealing film (Second inorganic sealing film)

30 Aging apparatus

32 Housing

32(1) Floor of housing

33 Chamber shelf table

34 Chamber

36 Chamber shelf

37 Chamber outer surface

38 Installing portion

39 Working shelf

40 Rotating portion

42 Rotating shaft

50 Mother substrate

55 Aging target object

60 Hot air blower device

61 Hot air blower device

65 Exhaust mechanism

66 Ventilation port

70 Door

C Central position

1: An aging apparatus for aging a plurality of aging target objects by installing the plurality of aging target objects within a chamber,
wherein the chamber has a cylindrical shape,
a chamber shelf is rotatably disposed in an interior of the chamber,
the chamber shelf enables the plurality of aging target objects to be installed in a direction of a rotating shaft, and
the chamber shelf has an arc shape in a plan view from the direction of the rotating shaft.

2. (canceled)

3: The aging apparatus according to claim 1,
wherein the rotating shaft is positioned at a center of the chamber.

4: The aging apparatus according to claim 1,
wherein the chamber shelf rotates at a rotation speed of from 1 or more revolutions to 10 or less revolutions per minute.

5: The aging apparatus according to claim 1,
wherein a hot air blower device is provided at an upper portion of the chamber, and
an exhaust mechanism is provided at a lower portion of the chamber.

6: The aging apparatus according to claim 1,
wherein the chamber shelf includes a plurality of installing portions for installing of the aging target objects, and
the chamber shelf includes ventilation ports provided individually for the installing portions.

7: The aging apparatus according to claim 6,
wherein the ventilation ports are provided at a chamber shelf rotating direction side of the corresponding installing portions.

8: The aging apparatus according to claim 6,
wherein the chamber shelf includes working shelves provided individually for the installing portions.

9: The aging apparatus according to claim 1.
wherein a door is provided in a housing that covers the chamber, and
opening and closing of the door is interlocked with rotation of the chamber shelf.

10: The aging apparatus according to claim 9,
wherein the rotation stops in association with opening of the door.

11: The aging apparatus according to claim 1,
wherein a chamber shelf table configured to rotate together with the chamber shelf is provided at a lower portion of the chamber shelf.

12: An aging apparatus for aging a plurality of aging target objects by installing the plurality of aging target objects within a chamber,
wherein the chamber has a cylindrical shape,
a chamber shelf is rotatably disposed in an interior of the chamber,
the chamber shelf enables the plurality of aging target objects to be installed in a direction of a rotating shaft,
the chamber shelf includes a plurality of installing portions for installing of the aging target objects,
the chamber shelf includes ventilation ports provided individually for the installing portions, and
the ventilation ports are provided at a chamber shelf rotating direction side of the corresponding installing portions.

13: The aging apparatus according to claim 12,
wherein the chamber shelf has an arc shape in a plan view from the direction of the rotating shaft.

14: The aging apparatus according to claim 12,
wherein the rotating shaft is positioned at a center of the chamber.

15: The aging apparatus according to claim 12,
wherein the chamber shelf rotates at a rotation speed of from 1 or more revolutions to 10 or less revolutions per minute.

16: The aging apparatus according to claim 12,
wherein a hot air blower device is provided at an upper portion of the chamber, and
an exhaust mechanism is provided at a lower portion of the chamber.

17: An aging apparatus for aging a plurality of aging target objects by installing the plurality of aging target objects within a chamber,
wherein the chamber has a cylindrical shape,
a chamber shelf is rotatably disposed in an interior of the chamber,
the chamber shelf enables the plurality of aging target objects to be installed in a direction of a rotating shaft,
the chamber shelf includes a plurality of installing portions for installing of the aging target objects,
the chamber shelf includes ventilation ports provided individually for the installing portions, and
the chamber shelf includes working shelves provided individually for the installing portions.

18: The aging apparatus according to claim 17,
wherein the chamber shelf has an arc shape in a plan view from the direction of the rotating shaft.

19: The aging apparatus according to claim 17,
wherein the rotating shaft is positioned at a center of the chamber.

20: The aging apparatus according to claim 17,
wherein the chamber shelf rotates at a rotation speed of from 1 or more revolutions to 10 or less revolutions per minute.

21: The aging apparatus according to claim 17,
wherein a hot air blower device is provided at an upper portion of the chamber, and
an exhaust mechanism is provided at a lower portion of the chamber.
